(19) United States
(12) Patent Application Publication
(10) Pub. No.: US 2012/0038476 A1
(43) Pub. Date: Feb. 16, 2012

(54) ANTI-THEFT DEVICE FOR A LAPTOP COMPUTER

(76) Inventor: Tung-Yi LIN, Banchiau City (TW)

(21) Appl. No.: 12/854,624

(22) Filed: Aug. 11, 2010

(51) Int. Cl. G08B 29/00

(52) U.S. Cl. 340/506

(57) ABSTRACT

The present invention includes a monitoring end device and a warning end device. When the monitoring end device is placed on a laptop computer or connected with the laptop computer, if the monitoring end device is displaced by vibration or a distance detection unit loses a wireless signal of a transmission or receiving unit, then a warning sound will be sent out through a loud speaker. At this time, the warning end device also produces vibration and a warning sound through a vibration unit and a loud speaker, thereby warning and informing a user of a safety condition of the laptop computer.

### BACKGROUND OF THE INVENTION

a) Field of the Invention

The present invention relates to an anti-theft device and more particularly to an anti-theft device for a laptop computer, which achieves monitoring and warning functions through detection of vibration, distance and signal.

b) Description of the Prior Art

After widespread of a wireless network in a public space, people can bring a laptop computer to surf on the Internet at a place like an internet café, a coffee shop or a library. However, an associated problem is that the computer can be stolen; for example, when a person uses a laptop computer in an internet café and has to leave temporarily, the laptop computer may be stolen. To solve this problem, some café chain stores abroad will provide mechanical computer locks on table tops, allowing clients to carry their own padlocks for use, which will be unsightly and the padlocks can be easily disengaged by thieves with tools. Next, there are people who develop an electronic anti-theft lock which is connected to a USB (Universal Serial Bus) port of a computer; that is, an end of a lead wire is connected to the computer and the other end is fixedly connected to a siren on a table top. Once the lead wire is removed or cut off, the siren will alert with audio and light. Nevertheless, thieves can still use tools to dismantle the siren and then steal the computers.

### SUMMARY OF THE INVENTION

The primary object of the present invention is to provide an anti-theft device for a laptop computer, which achieves monitoring and warning functions through detection of vibration, distance and signal.

In order to achieve the aforementioned object, the present invention includes a monitoring end device and a warning end device. The monitoring end device includes a universal serial port which is interconnected with a laptop computer by telecommunication, provides power to a power supply unit described below and transmits a connection signal to a central processor described below; the power supply unit which receives and stores power from the universal serial port and serves as a power source of the monitoring end device; a display unit which receives the power provided by the power supply unit to display a service condition of the monitoring end device; the central processor which receives the connection signal from the universal serial port, is provided with a vibration sensor and a distance detection unit, is interconnected with a loud speaker described below, as well as transmits signals of the distance detection unit or the vibration sensor to the display unit for displaying; a wireless antenna which is interconnected with the central processor, transmits and receives a wireless signal through the distance detection unit continuously, as well as matches with a wireless signal of a wireless antenna at the warning end; the loud speaker which is interconnected with the central processor to send out a warning sound; and an on/off switch which is interconnected with the power supply unit to control on or off of the monitoring end device.

The warning end device includes a power supply unit which is a power source of the warning end device; a display unit which receives the power provided by the power supply unit to display a service condition of the warning end device; a central processor which includes a distance detection unit, is interconnected with a loud speaker described below and transmits a signal of the distance detection unit to the display unit for displaying; a wireless antenna which is interconnected with the central processor, transmits and receives a wireless signal through the distance detection unit continuously, as well as inter-matches with a wireless signal of the wireless antenna at the monitoring end; a vibration unit which is interconnected with the central processor and receives the signal from the central processor to produce vibration; the loud speaker which is interconnected with the central processor and receives the signal from the central processor to send out a warning sound; and an on/off switch which is interconnected with the power supply unit to control on or off of the warning end device.

When the monitoring end device is placed on a laptop computer or is connected with a laptop computer through the universal serial port, as well as the monitoring end device and the warning end device are activated through the on/off switches, the wireless antennae of these two devices transmit wireless signals respectively for inter-matching between the two devices. When the monitoring end device is displaced by vibration, the distance detection unit loses the wireless signals of the transmission or receiving units, or the universal serial port is pulled out, the loud speaker will be activated through the central processor to send out the warning sound; in a mean time, through the central processor, the loud speaker will also be activated to send out the warning sound and the vibration unit will be activated to produce vibration by the warning end device, thus preventing the laptop computer from being stolen.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a monitoring end device and a warning end device of an anti-theft device for a laptop computer, according to the present invention.

### DETAILED DESCRIPTION OF THE PREFERRED EMBODIMENTS

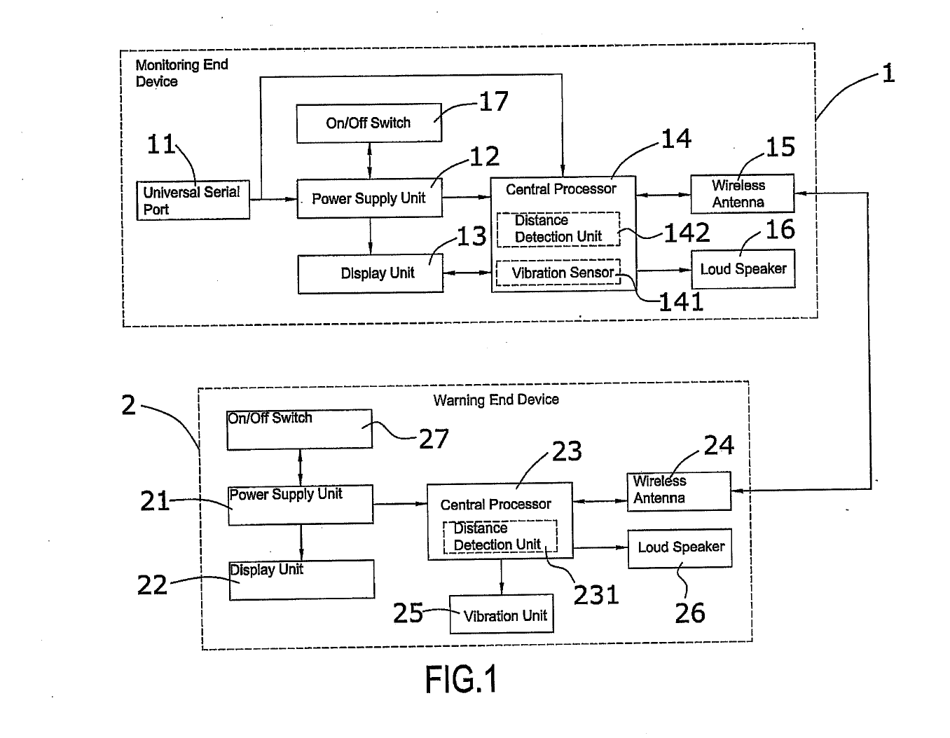

Referring to FIG. 1, it shows a schematic view of a monitoring end device and a warning end device of an anti-theft device for a laptop computer, according to the present invention, which comprises a monitoring end device 1 and a warning end device 2.

The monitoring end device 1 includes a universal serial port 11 which is connected with a laptop computer by telecommunication, provides power to a power supply unit 12 described below and transmits a connection signal to a central processor 14 described below, with that the aforementioned universal serial port 11 can be a USB interface; the power supply unit 12 which receives and stores power from the universal serial port 11 and serves as a power source of the monitoring end device 1, with that the aforementioned power supply unit 12 can be a rechargeable battery; a display unit 13 which receives the power provided by the power supply unit 12 to display a service condition of the monitoring end device 1, with that the aforementioned display unit 13 can be light bulb or an LCD (Liquid Crystal Display); the central processor 14 which receives a connection signal from the universal serial port 11, is provided with a vibration sensor 141 and a distance detection unit 142, is interconnected with a loud speaker 16 described below, and transmits a signal of the distance detection unit 142 or the vibration sensor 141 to the display unit 13 for displaying; a wireless antenna 15 which is interconnected with the central processor 14, transmits and receives a wireless signal through the distance detection unit 142 continuously, as well as inter-matches with a wireless signal of a wireless antenna at the warning end device 2, with that the aforementioned wireless antenna 15 can be an RFID (Radio Frequency Identification) antenna, a Bluetooth antenna, a 2.4 G antenna or an infrared antenna; the loud speaker 16 which is interconnected with the central processor 14 to send out a warning sound; and an on/off switch 17 which is interconnected with the power supply unit 12 to control on or off of the monitoring end device 1.

When the monitoring end device 1 is activated through the on/off switch 17, the power supply unit 12 will provide the power needed by the device and a condition of power supply will be displayed through the display unit 13. After the universal serial port 11 has been connected with a laptop computer, the power can be provided to the power supply unit 12 and a signal can be transmitted to the central processor 14, allowing the central processor 14 to be aware of that the monitoring end device 1 has already been connected with the laptop computer. In addition, through the wireless signal, the wireless antenna 15 will inter-match with the warning end device 2 which is described below. Furthermore, the wireless antenna 15 will transmit another connection signal to the distance detection unit 142 of the central processor 14, thereby entering into a monitoring state. When the monitoring end device 1 senses vibration through the vibration sensor 141 or when the universal serial port 11 is disconnected from the laptop computer, the central processor 14 will transmit a signal to activate the loud speaker 16 which sends out a warning sound to deter a thief. In a mean time, the wireless antenna 15 will transmit a signal to the warning end device 2 to activate the warning function, informing a laptop computer user. Moreover, when the distance detection unit 142 is unable to receive the connection signal of the wireless antenna 15, the central processor 14 will still transmit a signal to activate the loud speaker 16 which sends out the warning sound to deter a thief.

The warning end device 2 includes a power supply unit 21 which is a power source of the warning end device 2, with that the aforementioned power supply unit 21 can be a rechargeable battery; a display unit 22 which receives the power provided by the power supply unit 21 to display a service condition of the warning end device 2, with that the aforementioned display unit 22 can be a light bulb or an LCD; a central processor 23 which includes a distance detection unit 231, is interconnected with a loud speaker 26 described below and transmits a signal of the distance detection unit 231 to the display unit 22 for displaying; a wireless antenna 24 which is interconnected with the central processor 23, transmits and receives a wireless signal through the distance detection unit 231 continuously, as well as inter-matches with the wireless signal of the wireless antenna 15 at the monitoring end device 1, with that the aforementioned wireless antenna 24 can be an RFID antenna, a Bluetooth antenna, a 2.4 G antenna or an infrared antenna; a vibration unit 25 which is interconnected with the central processor 23 and receives the signal from the central processor 23 to produce vibration; the loud speaker 26 which is interconnected with the central processor 23 and receives the signal from the central processor 23 to send out a warning sound; and an on/off switch 27 which is interconnected with the power supply unit 21 to control on or off of the warning end device 2.

When the warning end device 2 is activated through the on/off switch 27, the power supply unit 21 will provide the power needed by the warning end device 2, and a condition of power supply will be displayed through the display unit 22. At this time, the wireless antenna 24 will inter-match with the monitoring end device 1 through the wireless signal and transmits a signal to the distance detection unit 231 of the central processor 23, thereby entering into a monitoring state. When the distance detection unit 231 is unable to receive the connection signal of the wireless antenna 24, the central processor 23 will transmit a signal to activate the loud speaker 26 and the vibration unit 25 respectively, and the loud speaker 26 will send out the warning sound, whereas the vibration unit 25 will produce vibration, thereby informing the laptop computer user. On the other hand, when the wireless antenna 24 receives a warning signal from the monitoring end device 1, the loud speaker 26 and the vibration unit 25 can be also activated to achieve the aforementioned effects.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An anti-theft device for a laptop computer comprising a monitoring end device and a warning end device; the monitoring and warning functions are thereby achieved through detection of vibration, distance and signals.

2. The anti-theft device for a laptop computer according to claim 1, wherein the monitoring end device includes:
a power supply unit which is a power source of the monitoring end device;
a display unit which receives the power provided by the power supply unit to display a service condition of the monitoring end device;
a central processor which includes a vibration sensor and a distance detection unit, is interconnected with a loud speaker, and transmits a signal of the distance detection unit or the vibration sensor to the display unit for displaying;
a wireless antenna which is interconnected with the central processor, transmits and receives a wireless signal through the distance detection unit continuously, as well as inter-matches with a wireless signal of a wireless antenna of a warning end device;
a loud speaker which is interconnected with the central processor to send out a warning sound; and
an on/off switch which is interconnected with the power supply unit to control on or off of the monitoring end device.

3. The anti-theft device for a laptop computer according to claim 1, wherein the monitoring end device includes a universal serial port which is connected with a laptop computer by telecommunication, provides power to the power supply unit and transmits a connection signal to the central processor, with that when the universal serial port is pulled out, the warning function is carried out through the central processor.

4. The anti-theft device for a laptop computer according to claim 2, wherein the monitoring end device includes a universal serial port which is connected with a laptop computer by telecommunication, provides power to the power supply unit and transmits a connection signal to the central processor, with that when the universal serial port is pulled out, the warning function is carried out through the central processor.

5. The anti-theft device for laptop computer according to claim 3, wherein the universal serial port is a USB (Universal Serial Bus) interface.

6. The anti-theft device for a laptop computer according to claim 4, wherein the universal serial port is a USB interface.

7. The anti-theft device for a laptop computer according to claim 2, wherein the warning end device includes:
a power supply unit which is a power source of the warning end device;
a display unit which receives the power provided by the power supply unit to display a service condition of the warning end device;
a central processor which includes a distance detection unit, is interconnected with a loud speaker, and transmits a signal of the distance detection unit to the display unit for displaying;
a wireless antenna which is interconnected with the central processor, transmits and receives a wireless signal through the distance detection unit continuously, as well as inter-matches with a wireless signal of a wireless antenna of a monitoring end device;
a vibration unit which is interconnected with the central processor and receives a signal from the central processor to produce vibration;
a loud speaker which is interconnected with the central processor to send out a warning sound; and
an on/off switch which is interconnected with the power supply unit to control on or off of the warning end device.
